(19) United States
(12) Patent Application Publication
(10) Pub. No.: US 2015/0070794 A1
(43) Pub. Date: Mar. 12, 2015

(54) TOUCH PANEL AND DECORATION PANEL THEREOF

(71) Applicant: WINTEK CORPORATION, Taichung City (TW)

(72) Inventors: Yi-Chun Wu, Hualien County (TW); Wun-Yi Shie, Taichung City (TW); Chi-Yuan Hung, New Taipei City (TW); Chun-Chieh Huang, Taichung City (TW)

(21) Appl. No.: 14/474,188

(22) Filed: Sep. 1, 2014

(30) Foreign Application Priority Data
Sep. 6, 2013 (TW) 102132300

(51) Int. Cl. G06F 1/16; G02B 5/08

(52) U.S. Cl. CPC G06F 1/1692; G02B 5/08; G02B 5/0816
USPC 359/838

(57) ABSTRACT

A touch panel, having a transparent region and a decoration region disposed on at least one side of the transparent region, includes a first substrate, a first decoration layer, a touch sensing unit, a first conductive line and a first opaque reflection layer. The first decoration layer is disposed on the first substrate and the first decoration layer is disposed in the decoration region. The touch sensing unit is at least disposed in the transparent region. The first conductive line is disposed in the decoration region and electrically connected to the touch sensing unit. The first opaque reflection is disposed on the first decoration layer and the first opaque reflection is disposed in the decoration region. The first decoration layer is disposed between the first substrate and the first opaque reflection layer.

### BACKGROUND OF THE INVENTION

1. Field of the Invention

The present invention generally relates to a touch panel and a decoration panel thereof, and more particularly, to a touch panel including an opaque reflection layer disposed in a decoration region and a decoration panel thereof.

2. Description of the Prior Art

Please refer to FIG. 1. FIG. 1 is a schematic diagram illustrating a conventional touch panel 100. As shown in FIG. 1, the conventional touch panel 100 includes a cover glass 110. A plurality of color ink layers 120 and a conductive line 130 are orderly stacked on an inner surface 110B of the cover glass 110 within a peripheral region BA. A touch sensing unit 130S is disposed in a touch sensing region AA, and the touch sensing unit 130S is electrically connected to the conductive line 130 in the peripheral region BA. The color ink layers 120 are used to form color mixing effects at the peripheral region BA of the touch panel 100 and present required color from a side of an outer surface 110A of the cover glass 110. However, a light shielding performance of one single color ink layer 120 is generally insufficient, especially when the color ink layer 120 is not a black ink layer, and the total thickness of the color ink layers 120 has to be thick enough for providing required light shielding performance. Generally, the total thickness of the stacked color ink layers 120 has to be thicker than 10 micrometers so as to generate sufficient light shielding result. However, the touch sensing unit 130S or/and the conductive line 130 may crack at the edge of the stacked color ink layers 120 during the manufacturing processes because the total thickness of the color ink layers 120 is too thick or the edge of the stacked color ink layers 120 is too uneven, and problems related to reliability may occur accordingly.

### SUMMARY OF THE INVENTION

It is one of the objectives of the present invention to provide a touch panel. An opaque reflection layer is disposed in the decoration region so as to make a collocated decoration layer thinner and enhance a presented color purity of the decoration layer.

To achieve the purposes described above, a preferred embodiment of the present invention provides a touch panel. The touch panel has a transparent region and a decoration region disposed on at least one side of the transparent region. The touch panel includes a first substrate, a first decoration layer, a touch sensing unit, a first conductive line and a first opaque reflection layer. The first decoration layer is disposed on the first substrate and in the decoration region. The touch sensing unit is at least disposed in the transparent region. The first conductive line is disposed in the decoration region. The first conductive line is electrically connected to the touch sensing unit. The first opaque reflection layer is disposed on the first decoration layer and in the decoration region. The first decoration layer is disposed between the first substrate and the first opaque reflection layer.

To achieve the purposes described above, a preferred embodiment of the present invention provides decoration panel of a touch panel. The decoration panel has a transparent region and a decoration region disposed on at least one side of the transparent region. The decoration panel includes a first substrate, a first decoration layer and a first opaque reflection layer. The first decoration layer is disposed on the first substrate and in the decoration region. The first opaque reflection layer is disposed on the first decoration layer and in the decoration region. The first decoration layer is disposed between the first substrate and the first opaque reflection layer.

In the present invention, the opaque reflection layer disposed in the decoration region may be used to enhance a presented color purity of the decoration layer. Additionally, the opaque reflection layer may be used to make the collocated decoration layer thinner, the crack issues of the subsequently formed conductive lines and touch sensing units on the decoration layer may become minor, and the reliability may be enhanced because the terrain formed by the decoration layer become relatively smooth. The related manufacturing yield may also be improved accordingly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a conventional touch panel.

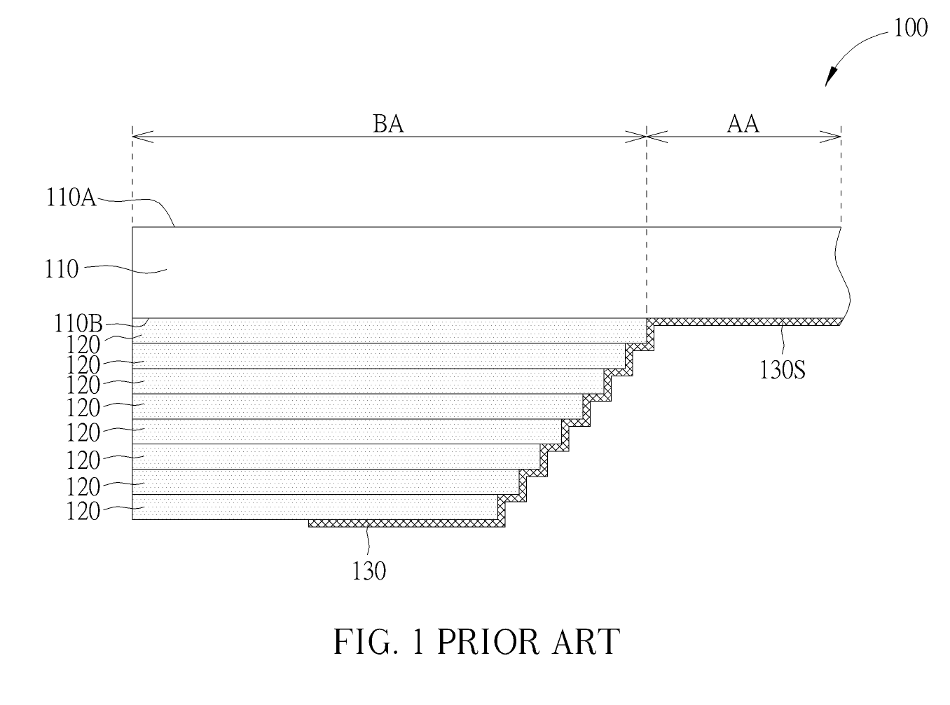

FIG. 2 is a schematic diagram illustrating a touch panel according to a first preferred embodiment of the present invention.

FIG. 3 is a schematic cross-sectional diagram taken along a line A-A′ in FIG. 2.

FIG. 4 is a schematic diagram illustrating a touch panel according to a second preferred embodiment of the present invention.

FIG. 5 is a schematic diagram illustrating a touch panel according to a third preferred embodiment of the present invention.

FIG. 6 is a schematic diagram illustrating a touch panel according to a fourth preferred embodiment of the present invention.

FIG. 7 is a schematic diagram illustrating a touch panel according to a fifth preferred embodiment of the present invention.

FIG. 8 is a schematic diagram illustrating a touch panel according to a sixth preferred embodiment of the present invention.

FIG. 9 is a schematic diagram illustrating a touch panel according to a seventh preferred embodiment of the present invention.

FIG. 10 is a schematic diagram illustrating a touch panel according to an eighth preferred embodiment of the present invention.

FIG. 11 is a schematic diagram illustrating a touch panel according to a ninth preferred embodiment of the present invention.

FIG. 12 is a schematic diagram illustrating a touch panel according to a tenth preferred embodiment of the present invention.

FIG. 13 is a schematic diagram illustrating a touch panel according to an eleventh preferred embodiment of the present invention.

FIG. 14 is a schematic diagram illustrating a touch panel according to a twelfth preferred embodiment of the present invention.

### DETAILED DESCRIPTION

To provide a better understanding of the present invention to the skilled users in the technology of the present invention, preferred embodiments will be detailed as follows. The preferred embodiments of the present invention are illustrated in the accompanying drawings with numbered elements to elaborate the contents and effects to be achieved.

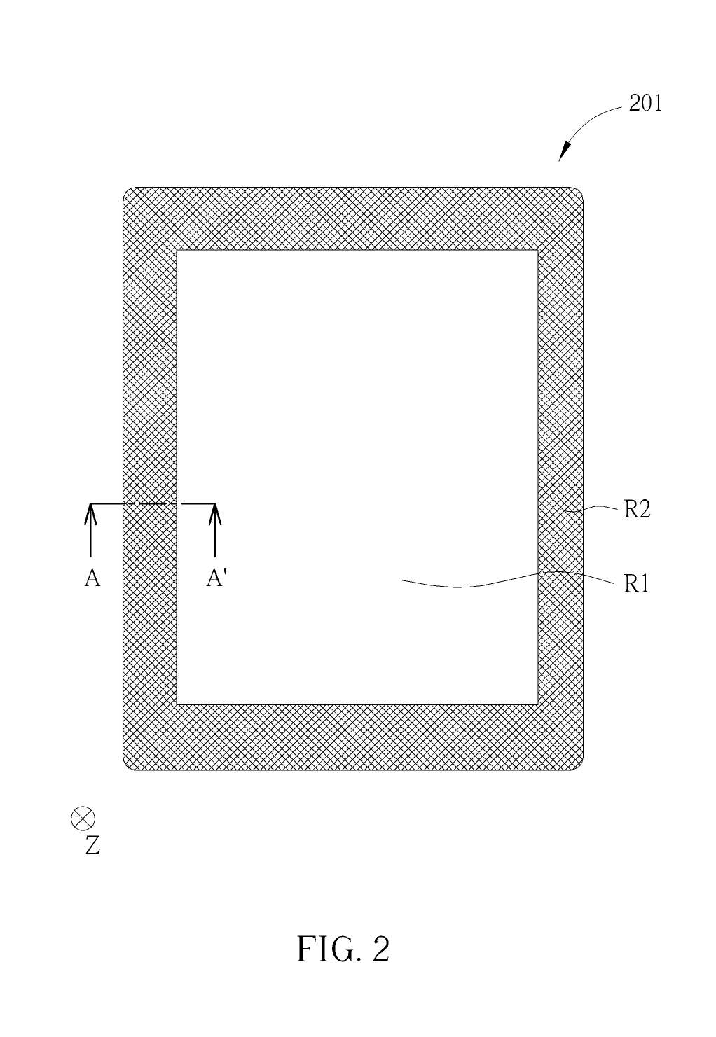

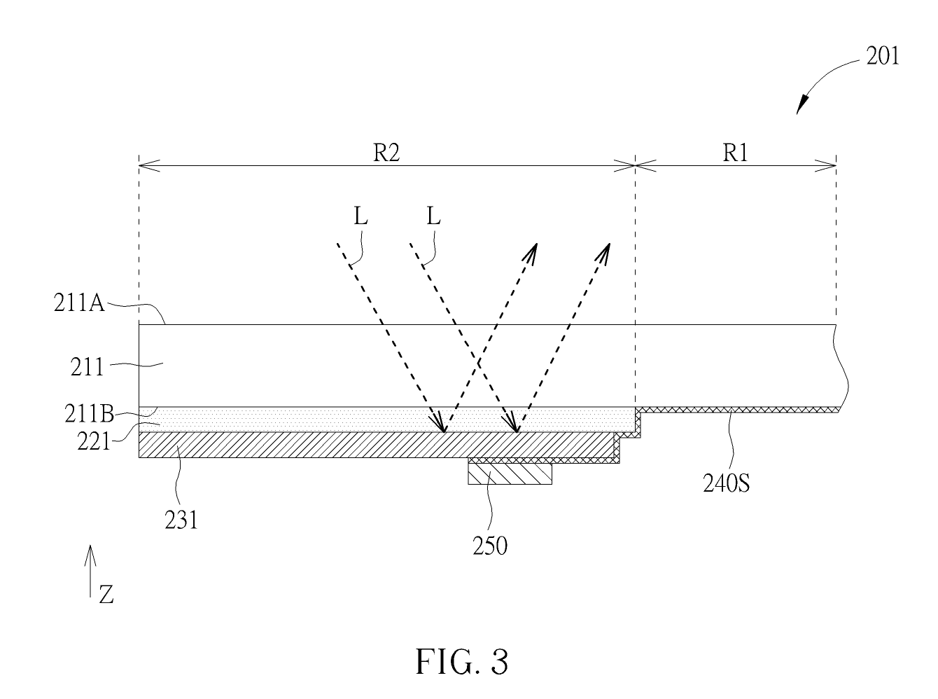

Please refer to FIG. 2 and FIG. 3. FIG. 2 is a schematic diagram illustrating a touch panel according to a first preferred embodiment of the present invention. FIG. 3 is a schematic cross-sectional diagram taken along a line A-A′ in FIG. 2. Please note that the figures are only for illustration and the figures may not be to scale. The scale may be further modified according to different design considerations. As shown in FIG. 2 and FIG. 3, a touch panel 201 is provided in this embodiment. The touch panel 201 has a transparent region R1 and a decoration region R2 disposed on at least one side of the transparent region R1. In this embodiment, the decoration region R2 surrounds the transparent region R1 preferably, but not limited thereto. The touch panel 201 includes a first substrate 211, a first decoration layer 221, a first opaque reflection layer 231, a touch sensing unit 240S and a first conductive line 250. The first substrate 211 has a first surface 211A and a second surface 211B opposite to the first surface 211A. The first substrate 211 may include a glass substrate, a ceramic substrate, a plastic substrate or substrates made of other appropriate materials. The first decoration layer 221 is disposed on the first substrate 211 and disposed in the decoration region R2. The touch sensing unit 240S is at least partially disposed in the transparent region R1. The first conductive line 250 is disposed in the decoration region R2. The touch sensing unit 240S in this embodiment partially extends to the decoration region R2 so as to contact the first conductive line 250 in the decoration region R2 and be electrically connected to the first conductive line 250. The first opaque reflection layer 231 is disposed on the first decoration layer 221 and disposed in the decoration region R2. The first decoration layer 221 is disposed between the first substrate 211 and the first opaque reflection layer 231. A reflectance of the first opaque reflection layer 231 is higher than or equal to 30%.

In this embodiment, the first decoration layer 221, the first opaque reflection layer 231, the touch sensing unit 240S and the first conductive line 250 are all disposed on a side of the second surface 211B of the first substrate 211, but not limited thereto. The first decoration layer 221 is used to present required color effect from the first surface 211A of the first substrate 211. The first decoration layer 221 is a non-black decoration layer preferably, but not limited thereto. For example, the first decoration layer 221 may be a white decoration layer. Single or multiple layers of color inks, color resists or other materials with color or texture effects may be used to form the first decoration layer 221. An optical density (OD) of the first opaque reflection layer is higher than or equal to 2 preferably so as to generate required opaque effect. Additionally, a light beam L irradiating from the first surface 211A and passing through the first substrate 211 and the first decoration layer 221 may be reflected by the first opaque reflection layer 231 and emitted from the first surface 211A because of the first opaque reflection layer 231 with high reflectance. The presented color purity of the first decoration layer 221 may be accordingly enhanced by the first opaque reflection layer 231. In addition, the first opaque reflection layer 231 may also be used to shield the first conductive line 250 from being distinguished from the side of the first surface 211A, and the thickness of the first decoration layer 221 doesn't have to be increased for generating shielding effects. The required thickness of the first decoration layer 221 may become thinner, and the crack issues of the touch sensing unit 240S and/or the first conductive line 250 subsequently formed on the first decoration layer 221 may become minor, and the reliability may be enhanced because the terrain formed by the first decoration layer become relatively smooth. The manufacturing yield and reliability of the touch panel 201 may also be improved accordingly. In this embodiment, the thickness of the first decoration layer 221 substantially ranges between 20 angstroms and 10 micrometers, and a thickness of the first opaque reflection layer 231 is preferably thinner than or equal to 2 micrometers so as to reduce the total thickness of the touch panel 201, but not limited thereto.

It is worth noting that, the first conductive line 250 and the touch sensing unit 240S in this embodiment are at least partially disposed on the first opaque reflection layer 231, and the first opaque reflection layer 231 is at least partially disposed between the first conductive line 250 and the first decoration layer 221. Therefore, the first opaque reflection layer 231 is preferably an insulation layer so as to reduce influence on the electrical properties of the first conductive line 250 and the touch sensing unit 240S, but not limited thereto. For example, the materials of the first opaque reflection layer 231 may include mirror effect ink (for example, mirror silver), silver ink, multiple layered film or insulating reflection layers formed by non-conductive vacuum metallization (NCVM) processes. Additionally, the first opaque reflection layer 231 may also be a composite layer of a metal reflection layer and an insulation layer. In other words, materials with required reflectance and keeping the first conductive line 250 and the touch sensing unit 240S working normally may be used to form the first opaque reflection layer 231.

In this embodiment, the touch sensing unit 240S is used to perform touch sensing functions. The touch sensing unit 240S may include conductive mesh, triangle electrodes, stripe electrodes or polygonal electrodes made of single layer conductive material or multiple layered conductive materials. The first conductive line 250 is electrically connected to the touch sensing unit 240S, and the conductive line 250 is at least partially disposed in the decoration region R2 so as to be electrically connected to other outer units (not shown), such as a flexible printed circuit (FPC), and transmit or receive touch signals. The first conductive line 250 and the touch sensing unit 240S may respectively include transparent conductive materials such as indium tin oxide (ITO), indium zinc oxide (IZO), and aluminum zinc oxide (AZO), or other appropriate non-transparent conductive materials such as silver (Ag), aluminum (Al), copper (Cu), magnesium (Mg), molybdenum (Mo), a stack layer of the above-mentioned materials or an alloy of the above-mentioned materials, conductive particles, carbon nanotubes (CNTs) and nano silver, but not limited thereto. The first conductive line 250 and the touch sensing unit 240S may be made of an identical conductive material or different conductive materials according to design considerations. In addition, an electrical resistance of the first conductive line 250 is preferably lower than an electrical resistance of the touch sensing unit 240S so as to lower the resistance of the conductive wirings in the decoration region R2. For instance, the touch sensing unit 240S maybe made of transparent conductive materials with relatively higher resistivity, and the first conductive line 250 may preferably made of metal materials with relatively lower resistivity, but not limited thereto. The first opaque reflection layer 231 may also be used to shield the first conductive line 250 because the first opaque reflection layer 231 overlaps the first conductive line 250 along a vertical projective direction Z perpendicular to the first substrate 211.

The following description will detail the different embodiments of the present invention. To simplify the description, identical components in each of the following embodiments are marked with identical symbols. For making it easier to understand the differences between the embodiments, the following description will detail the dissimilarities among different embodiments and the identical features will not be redundantly described.

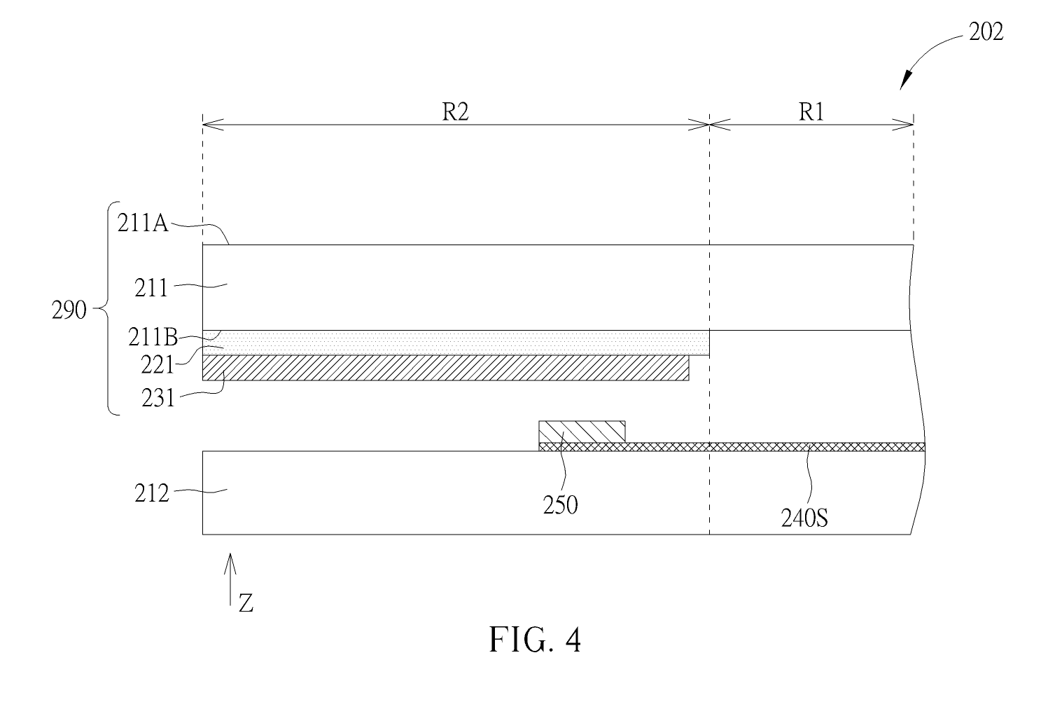

Please refer to FIG. 4. FIG. 4 is a schematic diagram illustrating a touch panel 202 according to a second preferred embodiment of the present invention. As shown in FIG. 4, the difference between the touch panel 202 in this embodiment and the touch panel in the first preferred embodiment is that the touch panel 202 further includes a second substrate 212 disposed opposite to the first substrate 211, and the first conductive line 250 and the touch sensing unit 240S are disposed on the second substrate 212. The first substrate 211 and the second substrate 212 may be combined together by an adhesive layer (not shown), but not limited thereto. Additionally, the conductive line 250 and the touch sensing unit 240S may be selectively disposed on a surface of the second substrate 212, and the surface may face the first substrate 211 or not face the first substrate 211. Apart from the second substrate 212 and the allocations of the first conductive line 250 and the touch sensing unit 240S in this embodiment, the other components, allocations, and material properties of the touch panel 202 in this embodiment are similar to those of the first preferred embodiment detailed above and will not be redundantly described. It is worth noting that the second substrate 212 and the first substrate 211 may be made of an identical material or different materials. For example, the first substrate 211 and the second substrate 212 may be a film substrate respectively, or the first substrate 212 maybe a cover substrate while the second substrate 212 is a film substrate, a glass substrate, a ceramic substrate, a plastic substrate or other substrate made of appropriate materials, but not limited thereto. It is worth noting that, in the touch panel 202, the first substrate 211, the first decoration layer 221 and the first opaque reflection layer 231 may be used to form a decoration panel 290 of the touch panel 202. In other words, the decoration panel 290 of the touch panel 202 has a transparent region R1 and a decoration region R2 disposed on at least one side of the transparent region R1. The decoration panel 290 includes the first substrate 211, the first decoration layer 221 and the first opaque reflection layer 231. The first decoration layer 221 is disposed on the first substrate 221 and in the decoration region R2. The first opaque reflection layer 231 is disposed on the first decoration layer 221 and in the decoration region R2. The first decoration layer 221 is disposed between the first substrate 211 and the first opaque reflection layer 231.

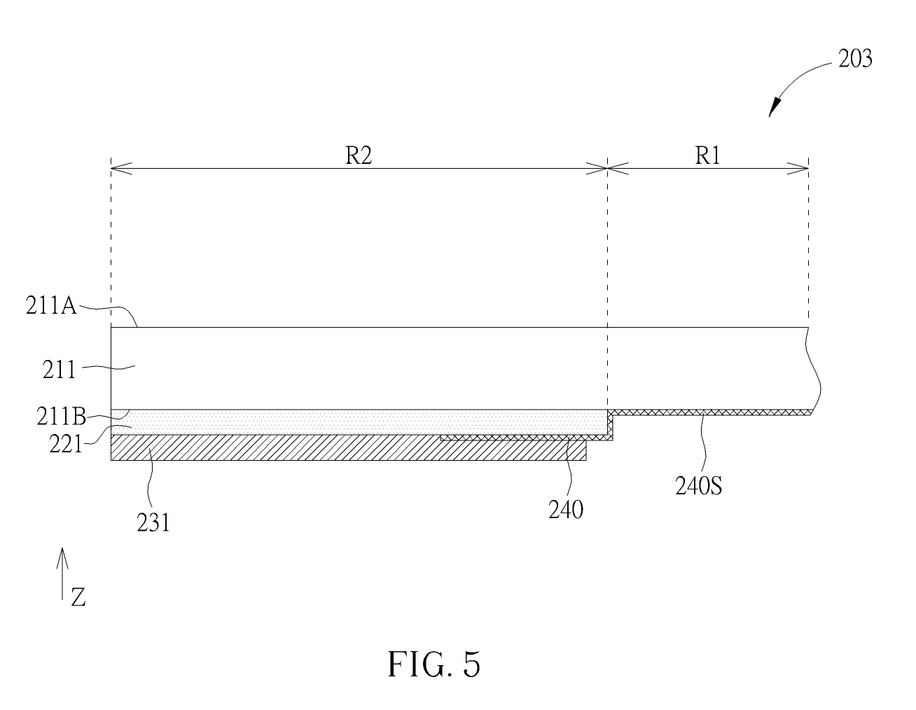

Please refer to FIG. 5. FIG. 5 is a schematic diagram illustrating a touch panel 203 according to a third preferred embodiment of the present invention. As shown in FIG. 5, the difference between the touch panel 203 in this embodiment and the touch panel in the first preferred embodiment is that the touch panel 203 includes a first conductive line 240 disposed in the decoration region R2. The first conductive line 240 is electrically connected to the touch sensing unit 240S. It is worth noting that the first conductive line 240 and the touch sensing unit 240S are preferably formed by an identical conductive material, and the first conductive line 240 and the touch sensing unit 240S are integrally and monolithically formed so as to lower the influence of high contact resistance generated at an interface between different materials, but not limited thereto. Additionally, the first conductive line 240 is at least partially disposed between the first opaque reflection layer 231 and the first decoration layer 221, and the first opaque reflection layer 231 may be used to protect the first conductive line 240. It is worth noting that, when the first opaque reflection layer 231 is composed of a stacked structure of one metal reflection layer and one insulation layer (not shown), the insulation layer is disposed adjacent to the first conductive line 240, i.e. the insulation layer is disposed between the metal reflection layer and the first conductive line 240 so as to keep the first conductive line 240 from being electrically influenced by the metal reflection layer.

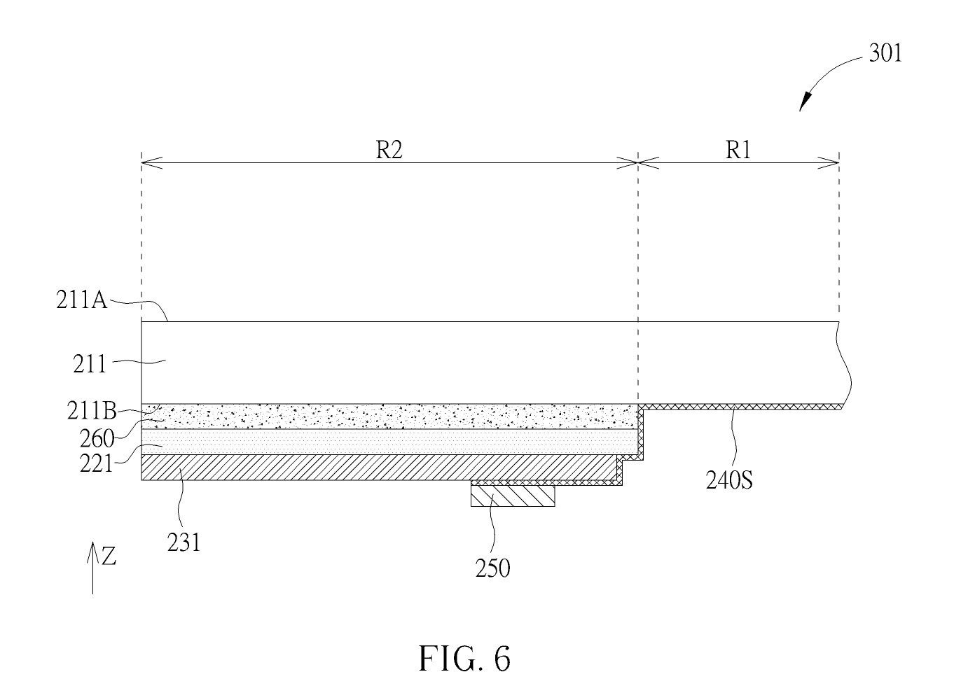

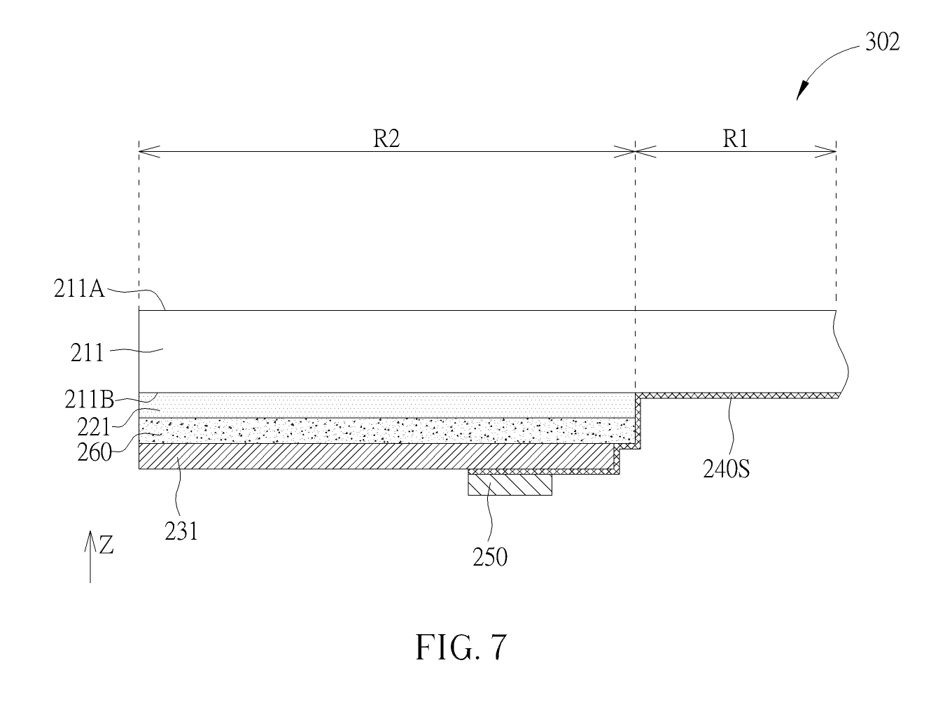

Please refer to FIG. 6 and FIG. 7. FIG. 6 is a schematic diagram illustrating a touch panel 301 according to a fourth preferred embodiment of the present invention. FIG. 7 is a schematic diagram illustrating a touch panel 302 according to a fifth preferred embodiment of the present invention. As shown in FIG. 6 and FIG. 7, the difference between the touch panel 301 and the touch panel in the first preferred embodiment is that the touch panel 301 further includes an optical compensation layer 260 disposed on the first substrate 211, and the difference between the touch panel 302 and the touch panel in the first preferred embodiment is that the touch panel 302 further includes the optical compensation layer 260 disposed on the first substrate 211. The optical compensation layer 260 is disposed in the decoration region R2, and the optical compensation layer 260 is disposed between the first substrate 211 and the first opaque reflection layer 231. The optical compensation layer 260 is used to improve the discoloring problem of the first decoration layer 221 under high temperature processes. The optical compensation layer 260 a color compensation layer or a refractive index compensation layer, but not limited thereto. For example, a refractive index of the optical compensation layer 260 may range between 1.6 and 2.5 preferably so as to provide required refractive index compensation effects, but not limited thereto. Additionally, a thickness of the optical compensation layer 260 is thinner than or equal to 2 micrometers, and the thickness of the optical compensation layer 260 preferably ranges 10 nanometers and 2 micrometers so as to reduce the thickness influence of the optical compensation layer 260 on the total thickness of the optical compensation layer 260, the first decoration layer 221 and the first opaque reflection layer 231 in the decoration region R2. As shown in FIG. 6, the optical compensation layer 260 may be disposed between the first substrate 211 and the first decoration layer 211. As shown in FIG. 7, in another embodiment, the optical compensation layer 260 maybe disposed between the first decoration layer 221 and the first opaque reflection layer 231 according to different design consideration.

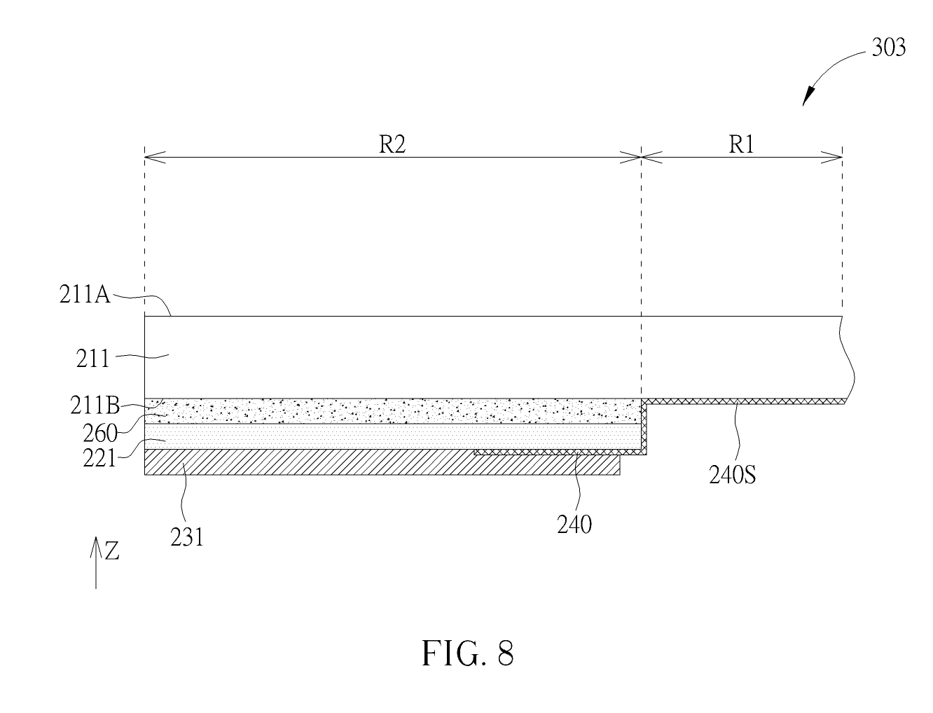

Please refer to FIG. 8. FIG. 8 is a schematic diagram illustrating a touch panel 303 according to a sixth preferred embodiment of the present invention. As shown in FIG. 8, the difference between the touch panel 202 in this embodiment and the touch panel in the fourth preferred embodiment is that, in the touch panel 303, the first conductive line 240 is at least partially disposed between the first opaque reflection layer 231 and the first decoration layer 221, and the first opaque reflection layer 231 maybe used to protect the first conductive line 240. Under this structure, the optical compensation layer 260 may be disposed between the first substrate 211 and the first decoration layer 211, and the optical compensation layer 260 may also be disposed between the first decoration layer 221 and the first opaque reflection layer 231 in other preferred embodiment of the present invention according to different design consideration.

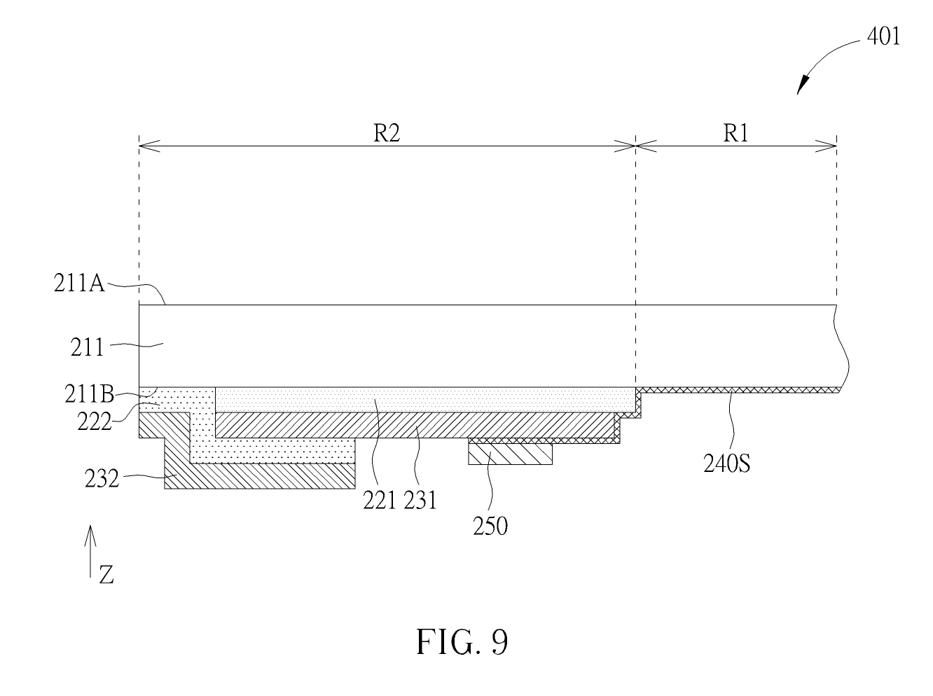

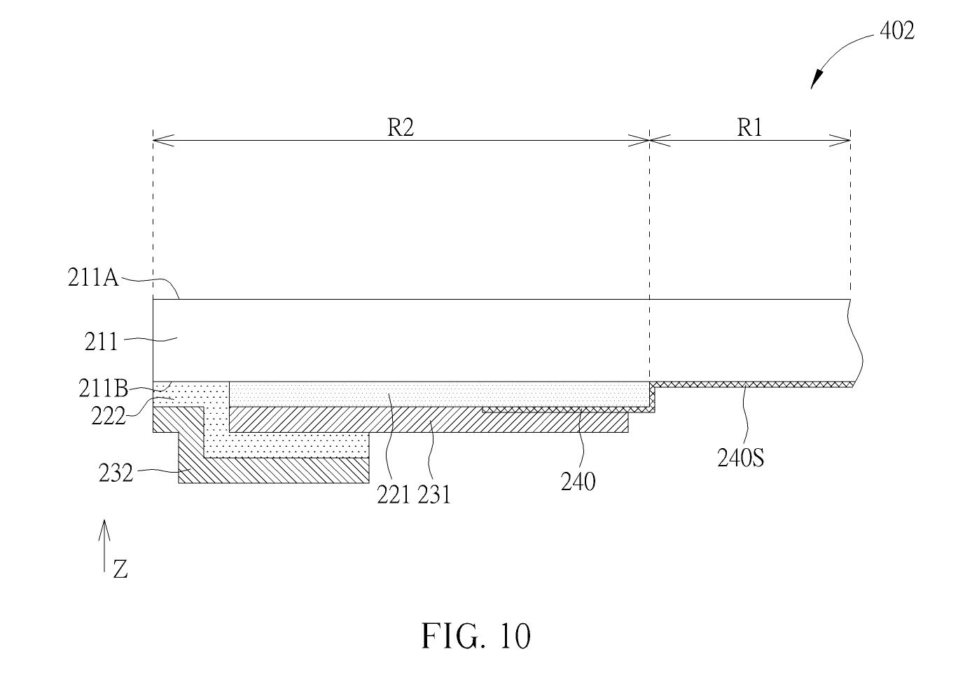

Please refer to FIG. 9 and FIG. 10. FIG. 9 is a schematic diagram illustrating a touch panel 401 according to a seventh preferred embodiment of the present invention. FIG. 10 is a schematic diagram illustrating a touch panel 402 according to an eighth preferred embodiment of the present invention. As shown in FIG. 9 and FIG. 10, the difference between the touch panel 401 and the touch panel in the first preferred embodiment is that the touch panel 401 further includes a second decoration layer 222 and a second opaque reflection layer 232, and the difference between the touch panel 402 and the touch panel in the third preferred embodiment is that the touch panel 402 further includes the second decoration layer 222 and the second opaque reflection layer 232. The second decoration layer 222 is disposed on the first substrate 211 and the first opaque reflection layer 231. The second decoration layer 222 is disposed in the decoration region R2, and the second decoration layer 222 covers an edge of the first decoration layer 221. A peripheral region of the first substrate 211 may be uncovered by the first decoration layer 221 and the first opaque reflection layer 231 after a cutting process of the first substrate 211 with first decoration layer 221, and a light leakage issue may occur accordingly. The second decoration layer 222 may be used to improve the light leakage issue described above. Additionally, the second opaque reflection layer 232 is disposed on the second decoration layer 222 and disposed in the decoration region R2. The second decoration layer 222 is disposed between the first substrate 211 and the second opaque reflection layer 232, and a reflectance of the second opaque reflection layer 232 is preferably higher than or equal to 30%. The presented color purity of the second decoration layer 222 may be enhanced by the second opaque reflection layer 232. The second decoration layer 222 and the second opaque reflection layer 232 at least partially overlap the first decoration layer 221 and the first opaque reflection layer 231 along the vertical projective direction Z so as to further ensure the appearance quality of the decoration region R2. The material properties of the second decoration layer 222 and the second opaque reflection layer 232 are similar to those of the first decoration layer 221 and the first opaque reflection layer 231 and will not be redundantly described.

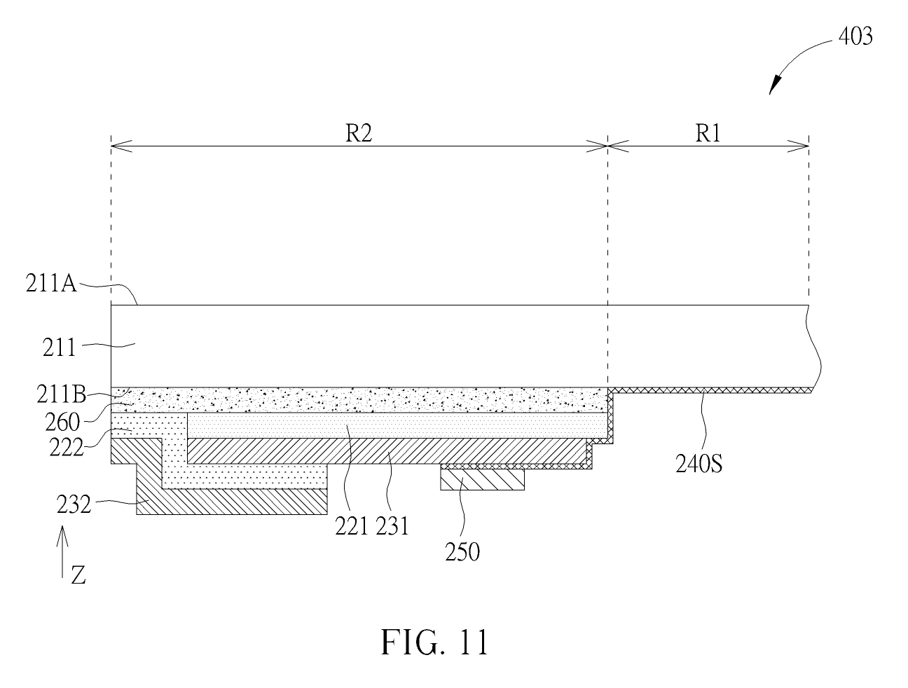

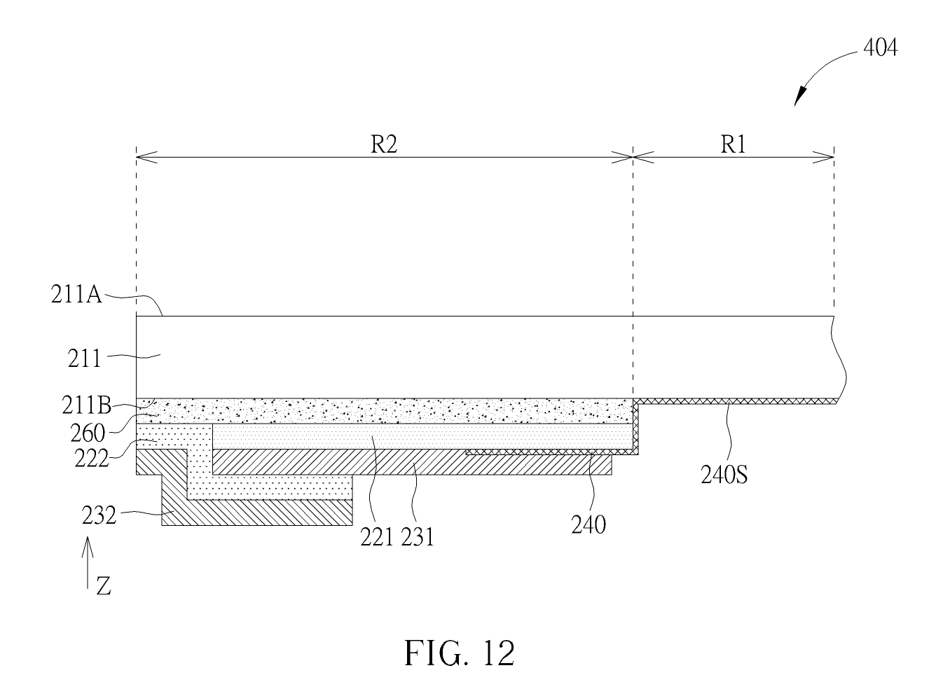

Please refer to FIG. 11 and FIG. 12. FIG. 11 is a schematic diagram illustrating a touch panel 403 according to a ninth preferred embodiment of the present invention. FIG. 12 is a schematic diagram illustrating a touch panel 404 according to a tenth preferred embodiment of the present invention. As shown in FIG. 11 and FIG. 12, the difference between the touch panel 403 and the touch panel in the seventh preferred embodiment is that the touch panel 403 further includes the optical compensation layer 260 disposed between the first substrate 211 and the first decoration layer 221, and the difference between the touch panel 404 and the touch panel in the eighth preferred embodiment is that the touch panel 404 further includes the optical compensation layer 260 disposed between the first substrate 211 and the first decoration layer 221. The optical compensation layer 260 disposed between the first substrate 211 and the first decoration layer 221 is used to improve the discoloring problem of the first decoration layer 221 and the second decoration layer 222 under high temperature processes. Additionally, in other preferred embodiments of the present invention, the optical compensation layer 260 may be selectively disposed between the first decoration layer 221 and the first opaque reflection layer 231, or the optical compensation layer may also be selectively disposed between the second decoration layer 222 and the second opaque reflection layer 232 so as to provide required optical compensation effects.

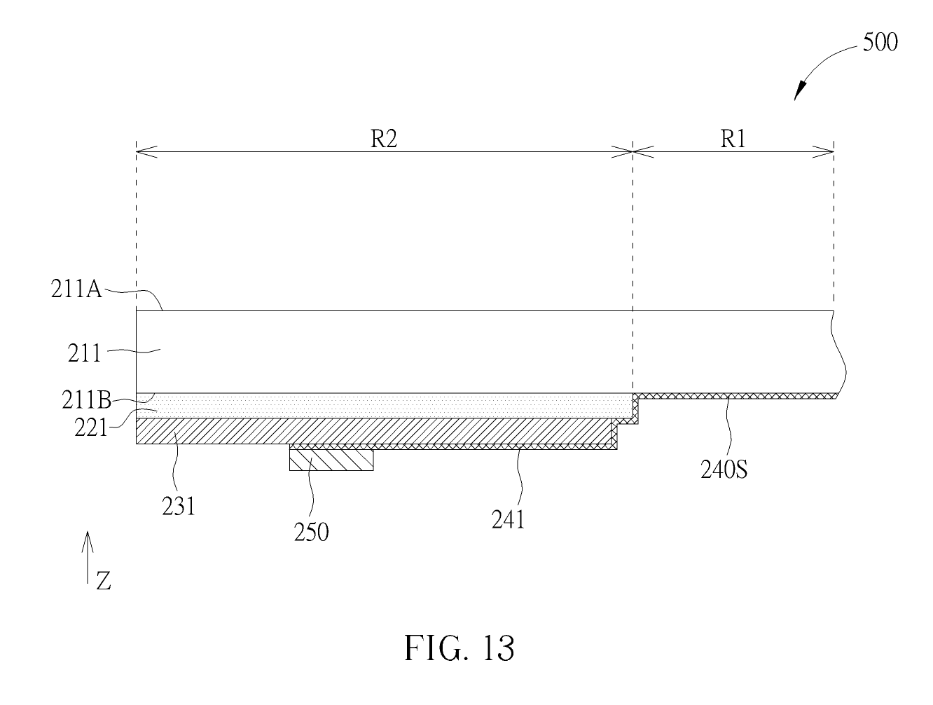

Please refer to FIG. 13. FIG. 13 is a schematic diagram illustrating a touch panel 500 according to an eleventh preferred embodiment of the present invention. As shown in FIG. 13, the difference between the touch panel 500 in this embodiment and the touch panel in the first preferred embodiment is that the touch panel 500 further includes a second conductive line 241, disposed in the decoration region R2. The second conductive line 241 is configured to electrically connect the touch sensing unit 240S and the first conductive line 250. It is worth noting that the second conductive line 241 and the touch sensing unit 240S are preferably made of an identical material, and the second conductive line 241 and the touch sensing unit 240S are integrally and monolithically formed. The second conductive line 241 is partially disposed between the first conductive line 250 and the first opaque reflection layer 231 preferably, but not limited thereto. In other preferred embodiments of the present invention, the first conductive line 250 may be at least partially disposed between the second conductive line 241 and the first opaque reflection layer 231 so as to form the electrical connection in different directions. In addition, the second conductive line 241 in this embodiment may also be selectively applied to the touch panels of the preferred embodiments described above.

One or more patterned openings (not shown) maybe selectively formed in the opaque reflection layer in all of the embodiments described above. A light source or a sensor may be disposed correspondingly to the pattern opening. The light source may be an LED light source, and the sensor may be an infrared receiver. The patterned opening may work as a button pattern, a light emitting hole for the LED light source, or a receiving hole for the sensor. In addition, the touch sensing unit 240S in all of the embodiments described above is only partially illustrated, and the whole structure of the touch sensing unit 240S is not limited to the local structure disclosed in the figures.

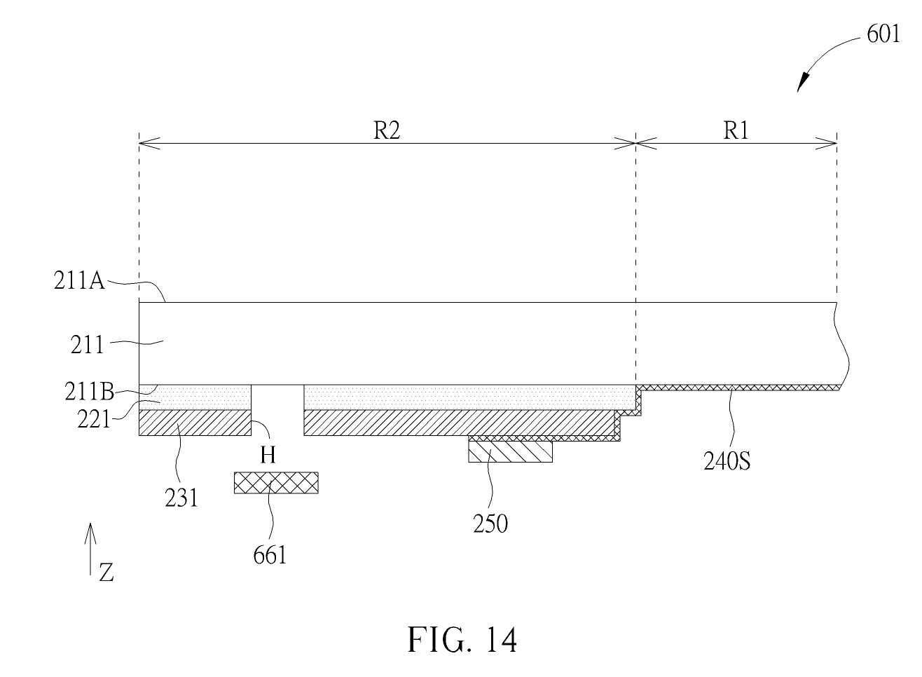

Please refer to FIG. 14. FIG. 14 is a schematic diagram illustrating a touch panel 601 according to a twelfth preferred embodiment of the present invention. As shown in FIG. 14, the difference between the touch panel 601 in this embodiment and the touch panel in the first preferred embodiment is that the touch panel 601 further includes a peripheral unit 661 disposed in the decoration region R2, and the first opaque reflection layer 231 has a patterned opening H disposed correspondingly to the peripheral unit 661. The peripheral unit 661 in this embodiment may include a light source, a sensor or other appropriate optical unit such as an image capturing device (like camera), but not limited thereto. The light source mentioned above may include an LED light source or other appropriate light sources. The sensor mentioned above may include an infrared sensor, optical near field sensor or other appropriate sensing devices. The patterned opening H may work as a button pattern, a light emitting hole for the LED light source, or a receiving hole for the sensor. Additionally, the patterned opening H penetrates the first decoration layer 221 and the first opaque reflection layer 231 preferably, but not limited thereto. For instance, when the patterned opening H work as a button pattern, the patterned opening H may only penetrate the first opaque reflection layer 231 so as to make the button pattern readable only as the light source is turned on and make the button pattern invisible as the light source is turned off. Additionally, a touch sensing electrode may be disposed correspondingly to the button pattern so as to provide touch functions on the button pattern. When the patterned opening H is disposed correspondingly to an indication light source, the patterned opening H may only penetrate the first opaque reflection layer 231 so as to make the patterned opening H visible only as the indication light source is turned on, but not limited thereto. The patterned opening H and the peripheral unit 661 in this embodiment may also be selectively applied to the touch panels of the preferred embodiments described above.

In addition, a strengthening layer (not shown) can also be provided and at least partially disposed in the transparent region R1. The strengthening layer is disposed between the first substrate 211 and the touch sensing unit 240S for improving the ability of impact resistance of the first substrate 211 and protecting the touch sensing unit 240S in all of the embodiments described above. The material of the strengthening layer may include transparent organic material, such as polyurethane (PU) group, polyimide (PI) group, epoxy resin group, phenol formaldehyde (PF) resin group, polyester group, silicon-containing rubber (such as polyisoprene rubber), silicon-containing material, rubber material, or composite organic material of the above-mentioned materials. In addition, the strengthening layer may have a composite material of organic material and inorganic material, such as a composite material including acrylic group material as the host doped with silica or Al₂O₃ particles, wherein the mix of organic material and inorganic material may be performed through chemical bonding or without chemical bonding. For example, the strengthening layer may include positive photoresist or negative photoresist including thermosetting resin or light curing resin. The strengthening layer may also be composed of inorganic material, such as SiO₂, SiNx, TiO₂ or SiOxNy, organic material, or organic material containing inorganic material.

To summarize the above descriptions, in the touch panel of the present invention, the opaque reflection layer disposed in the decoration region is used to enhance the presented color purity of the decoration layer. The opaque reflection layer may also be used to make the collocated decoration layer thinner, the crack issues of the subsequently formed conductive lines and the touch sensing units on the decoration layer may become minor, and the reliability may be enhanced because the terrain formed by the decoration layer become relatively smooth. The related manufacturing yield and reliability may also be improved accordingly. Additionally, the optical compensation layer is disposed in the decoration region so as to improve the discoloring problem of the decoration layer under high temperature processes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel, having a transparent region and a decoration region disposed on at least one side of the transparent region, the touch panel comprising:
a first substrate;
a first decoration layer, disposed on the first substrate and in the decoration region;
a touch sensing unit, at least disposed in the transparent region;
a first conductive line, disposed in the decoration region, wherein the first conductive line is electrically connected to the touch sensing unit; and
a first opaque reflection layer, disposed on the first decoration layer and in the decoration region, wherein the first decoration layer is disposed between the first substrate and the first opaque reflection layer.

2. The touch panel of claim 1, wherein a reflectance of the first opaque reflection layer is higher than or equal to 30%.

3. The touch panel of claim 1, wherein an optical density (OD) of the first opaque reflection layer is higher than or equal to 2.

4. The touch panel of claim 1, wherein the first opaque reflection layer is an insulation layer.

5. The touch panel of claim 1, wherein the first conductive line is at least partially disposed on the first opaque reflection layer, and the first opaque reflection layer is at least partially disposed between the first conductive line and the first decoration layer.

6. The touch panel of claim 1, further comprising a second substrate, disposed opposite to the first substrate, wherein the first conductive line and the touch sensing unit are disposed on the second substrate.

7. The touch panel of claim 1, further comprising a second conductive line, disposed in the decoration region, wherein the second conductive line is configured to electrically connect the touch sensing unit and the first conductive line.

8. The touch panel of claim 1, wherein the first conductive line is at least partially disposed between the first opaque reflection layer and the first decoration layer.

9. The touch panel of claim 1, further comprising an optical compensation layer, having a thickness thinner than or equal to 2 micrometers and disposed on the first substrate, wherein the optical compensation layer is disposed in the decoration region, and the optical compensation layer is disposed between the first substrate and the first opaque reflection layer.

10. The touch panel of claim 9, wherein the optical compensation layer is disposed between the first substrate and the first decoration layer.

11. The touch panel of claim 9, wherein the optical compensation layer is disposed between the first decoration layer and the first opaque reflection layer.

12. The touch panel of claim 9, wherein the optical compensation layer comprises a color compensation layer or a refractive index compensation layer.

13. The touch panel of claim 9, wherein a refractive index of the optical compensation layer ranges between 1.6 and 2.5.

14. The touch panel of claim 1, further comprising a second decoration layer, disposed on the first substrate and the first opaque reflection layer, wherein the second decoration layer is disposed in the decoration region, and the second decoration layer covers an edge of the first decoration layer.

15. The touch panel of claim 14, further comprising: a second opaque reflection layer, disposed on the second decoration layer and in the decoration region, wherein the second decoration layer is disposed between the first substrate and the second opaque reflection layer, and a reflectance of the second opaque reflection layer is higher than or equal to 30%.

16. The touch panel of claim 1, wherein the first decoration layer is a non-black decoration layer.

17. The touch panel of claim 1, wherein a thickness of the first decoration layer ranges between 20 angstroms and 10 micrometers.

18. The touch panel of claim 1, wherein a thickness of the first opaque reflection layer is thinner than or equal to 2 micrometers.

19. The touch panel of claim 1, further comprising a peripheral unit, wherein the first opaque reflection layer has a patterned opening, and the patterned opening is disposed correspondingly to the peripheral unit.

20. The touch panel of claim 19, wherein the peripheral unit comprises a light source or a sensor.

21. A decoration panel of a touch panel, having a transparent region and a decoration region disposed on at least one side of the transparent region, the decoration panel comprising:
a first substrate;
a first decoration layer, disposed on the first substrate and in the decoration region; and
a first opaque reflection layer, disposed on the first decoration layer and in the decoration region, wherein the first decoration layer is disposed between the first substrate and the first opaque reflection layer.
